(19) United States
(12) Patent Application Publication
(10) Pub. No.: US 2018/0285967 A1
(43) Pub. Date: Oct. 4, 2018

(54) System and Method for Controlling Access to a Rental Object

(71) Applicant: MASTERCARD ASIA/PACIFIC PTE. LTD., Singapore (SG)

(72) Inventors: Benjamin Charles Gilbey, Singapore (SG); Veronica Kuoh, Singapore (SG); Eric Jian Hui Lin, Singapore (SG)

(21) Appl. No.: 15/912,539

(22) Filed: Mar. 5, 2018

(30) Foreign Application Priority Data
Mar. 30, 2017 (SG) 10201702643Q

(51) Int. Cl. G06Q 30/06; G06Q 20/32; G06Q 20/40; G07F 17/00

(52) U.S. Cl. CPC G06Q 30/0645; G07F 17/0042; G06Q 20/4097; G06Q 20/3223

(57) ABSTRACT

A system and a method for controlling access to a rental object are disclosed. The system includes a processor and a memory unit coupled to the processor. The rental object is connected to a network. The memory unit is configured to store data received from a customer device. The data includes a code associated with the rental object and a payment request message responsive to the code. The processor is configured to process the payment request message and simultaneously instruct a merchant device, via the network, to enable the rental object for use by the customer.

### CROSS-REFERENCE TO RELATED APPLICATION

This application claims the benefit of and priority to Singapore Patent Application No. 10201702643Q filed Mar. 30, 2017. The entire disclosure of the above application is incorporated herein by reference.

### FIELD

The present disclosure relates broadly, but not exclusively, to a system and method for controlling access to a rental object.

### BACKGROUND

This section provides background information related to the present disclosure which is not necessarily prior art.

It is common to rent a device (e.g., a locker, a vehicle, an appliance, etc.), a facility (e.g., a toilet, a parking spot, a meeting room, etc.), or even a service. A rental typically involves payment of a fee from a customer to a merchant or vendor. The rental fee may be a flat rate or based on the usage parameters, such as duration, distance, size, and the like.

However, in traditional rental services, rental fee collection and administration and enforcement of the rental fees can be costly and time-consuming. For example, where the payment is made in cash (e.g., coins and/or small notes), a cashier may need to be employed, or regular collection from a secure cash box must be made. Customers may also find it a hassle to find the required cash to pay or to keep track of the rental receipts. On the other hand, where the payment can be made via a payment card, multiple terminals and dedicated payment gateways must be maintained to cater for different types of cards and card networks.

A need therefore exists to provide a system and method that seeks to address the above problems or provide a useful alternative.

### SUMMARY

This section provides a general summary of the disclosure, and is not a comprehensive disclosure of its full scope or all of its features. Aspects and embodiments of the disclosure are set out in the accompanying claims.

According to an aspect of the present disclosure, there is provided a system for controlling access to a rental object. The system comprises a processor and a memory unit coupled to the processor. The rental object is connected to a network. The memory unit is configured to store data received from a customer device, the data comprising a code associated with the rental object and a payment request message responsive to the code. The processor is configured to process the payment request message and simultaneously instruct a merchant device, via the network, to enable the rental object for use by the customer.

The payment request message may comprise a push payment request from a digital wallet in the customer device.

The code may comprise a merchant ID associated with the rental object, and the processor may be configured to process the payment request message based on the merchant ID.

The code may comprise rental information, and the processor may be configured to instruct the merchant device to enable the rental object for use by the customer based on the rental information.

The code associated with the rental object may comprise a barcode or a QR code.

The code associated with the rental object may comprise a static code.

The code associated with the rental object may comprise a dynamic code.

According to another aspect of the present disclosure, there is provided a method for controlling access to a rental object. The method comprises receiving, via a network, a payment request message from a customer device. The payment request is generated in response to the customer device acquiring a code associated with the rental object. The method further comprises processing the payment request message while simultaneously instructing a merchant device, via the network, to enable the rental object for use by the customer.

The payment request message may comprise a push payment request from a digital wallet in the customer device.

The code may comprise a merchant ID associated with the rental object, and processing the payment request message may comprise crediting the payment based on the merchant ID.

The code may comprise rental information, and the merchant device may be instructed to enable the rental object for use by the customer based on the rental information.

The code associated with the rental object may comprise a barcode, and acquiring the code may comprise scanning the barcode by the customer device.

The code associated with the rental object may comprise a QR code, and acquiring the code may comprise scanning the QR code by the customer device.

The code associated with the rental object may comprise a static code.

The code associated with the rental object may comprise a dynamic code.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. With that said, embodiments of the present disclosure will be better understood and readily apparent to one of ordinary skill in the art from the following written description, when read in conjunction with the drawings, in which:

FIG. 1 shows a general flow chart illustrating a method for controlling access to a rental object according to an example embodiment.

FIG. 2 shows a detailed flow chart of the method of FIG. 1.

FIG. 3 shows a schematic block diagram of a wireless device suitable for implementing the method of the example embodiments.

FIG. 4 shows a schematic block diagram illustrating a computer suitable for implementing the method and system of the example embodiments.

Corresponding reference numerals indicate corresponding parts throughout the several views of the drawings.

### DETAILED DESCRIPTION

Embodiments of the present disclosure will be described, by way of example only, with reference to the drawings. The description and specific examples included herein are intended for purposes of illustration only and are not intended to limit the scope of the present disclosure.

The example embodiments provide a method and system to control access to a rental object. Typically, such an object may be a physical device, equipment, or facility, and may be connected to a network, such as the Internet, in an environment understood by a skilled person as the Internet of Things (IoT), such that the object may be remotely controlled or manipulated without human intervention. For example, a network-connected rental bicycle may be remotely unlocked, or a gym door may be remotely opened, in an automatic manner when specific conditions are satisfied.

The example embodiments will now be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer, or other device, selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the present disclosure.

Furthermore, one or more of the steps of the computer program may be performed in parallel rather than sequentially. Such a computer program may be stored on any computer readable medium. The computer readable medium may include storage devices, such as magnetic or optical disks, memory chips, or other storage devices suitable for interfacing with a computer. The computer readable medium may also include a hard-wired medium, such as exemplified in the Internet system, or wireless medium, such as exemplified in the GSM, GPRS, 3G or 4G mobile telephone systems, as well as other wireless systems such as Bluetooth™ ZigBee™ , Wi-Fi, etc. The computer program when loaded and executed on such a computer effectively results in an apparatus that implements the steps of the preferred method.

The present disclosure may also be implemented as hardware modules. More particularly, in the hardware sense, a module is a functional hardware unit designed for use with other components or modules. For example, a module may be implemented using discrete electronic components, or it can form a portion of an entire electronic circuit, such as an Application Specific Integrated Circuit (ASIC) or Field Programmable Gate Array (FPGA). Numerous other possibilities exist. Those skilled in the art will appreciate that the system can also be implemented as a combination of hardware and software modules.

The present disclosure relates to methods for controlling access to a rental object. Currently, many merchants accept electronic payment transactions as an alternative to cash for the payment for products or services, for example, for rental or hire of an object. In such electronic payment transactions, a payment card may be used. As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers. In other words, in some instances, such a payment card may not exist in a physical form, but rather, may be in an electronic form comprising data stored in a digital (e.g., mobile) wallet.

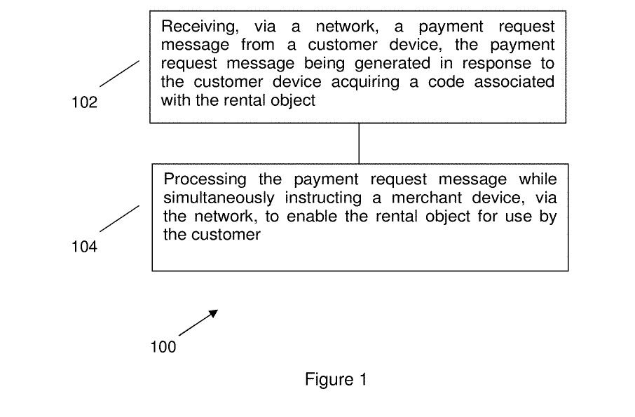

FIG. 1 shows a flow chart 100 illustrating a method for controlling access to a rental object according to an example embodiment. At step 102, a payment request is received from a customer device via a network. As described in more detail below, the payment request may be generated in response to the customer device acquiring a code associated with the rental object. At step 104, a processor processes the payment request while simultaneously instructing a merchant device, via the network, to enable the rental object for use by the customer.

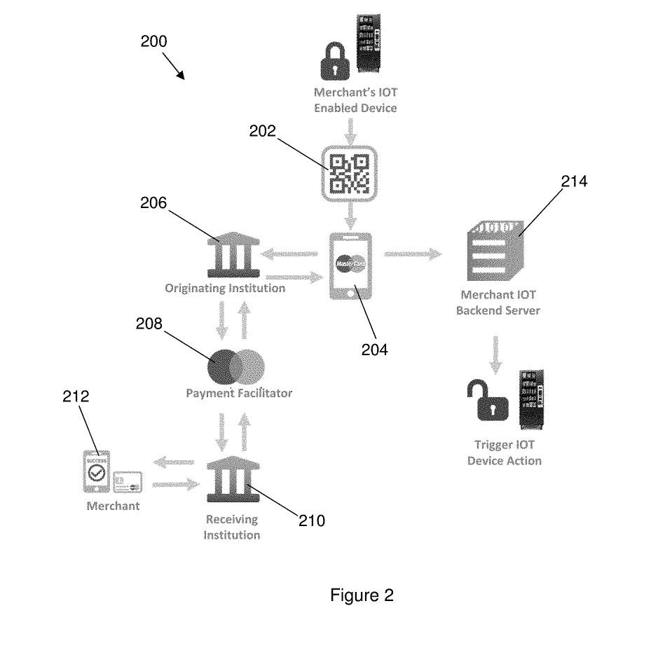

FIG. 2 shows a detailed flow chart 200 of the method of FIG. 1. In a typical implementation, the consumer visits a merchant to rent an unmanned IoT-enabled rental object, for example, a locker, a vending machine, a convenience store microwave oven, a washing machine, etc. In other words, the rental object is connected to a network, e.g., the Internet. As shown in FIG. 2, the rental object is initially locked or disabled. Details of the rental pricing are displayed together with or in the form of a code associated with the rental object, such as a barcode or a QR code. For example, the code may be a static code printed on a sticker or label in instances where the rental prices are relative stable or fixed-rates, or where the set-up cost should be kept low. Alternatively, a dynamic code may be generated on a screen associated with the rental object based on the selected type of service or usage, for example, wash-load of a washing machine, duration of use, etc. Such a dynamic code may be suitable in instances where there are multiple rental options, or where the rental pricing may be variable, for example, based on supply and demand information. The size and placement of the code preferably enables it to be acquired by a consumer device, such as a smart phone or tablet computer.

The customer device typically includes a digital wallet or mobile wallet app provided by a card issuer or an originating institution, card network or smart phone vendor, or a card-on-file (COF) with a particular merchant. Payment card details (e.g., primary account number (PAN), expiry date, card verification value (CVV)) are usually stored in the mobile wallet or COF system. For security, card information should be tokenized on the platform of the merchant or payment service provider (PSP)/payment facilitator (PF). The mobile wallet app preferably has person to merchant (P2M) capabilities, such as scanning of a barcode or QR code. Moreover, the mobile wallet app includes two sets of application programming interfaces (API), one for triggering a push payment request and one for enabling the rental object.

Referring to FIG. 2, after the consumer has selected the desired rental option/device, the consumer scans a corresponding code 202 using the consumer device 204 running the mobile wallet app. Once the code 202 is successfully acquired, a payment request is generated and sent to an Originating Institution (OI) 206 in a manner appreciated by a skilled person as push payment, and the consumer can confirm or authenticate the transaction by a personal identification number (PIN) or biometric data (e.g., voice, fingerprint, iris, etc.). The Originating Institution 206 verifies and secures available funds from a cardholder account associated with the consumer and undertakes the purchase transaction from a corresponding payment card to fund the payment. The Originating Institution 206 then debits the cardholder account and transmits the transaction data to a card network or payment facilitator 208.

The card network or payment facilitator 208 processes the payment request by having a switch that routes the transaction data, including a merchant ID stored in the QR code, to a Receiving Institution (RI) 210. The Receiving Institution 210, which is in communication with the payment facilitator, processes the transaction and notifies the merchant that the payment has been received. Thereafter, the Receiving Institution 210 typically credits the funds to a PAN or merchant account 212 associated with the merchant after a brief interval, for example, within 30 minutes of processing the transaction. The Receiving Institution 210 also confirms or acknowledges the payment to Originating Institution 206 via the payment facilitator 208.

In example embodiments, the card network or payment facilitator 208 also remotely enables the rental object for use by the consumer. This can happen simultaneously with the processing of the payment request. For example, as soon as payment facilitator 208 receives the message from the Originating Institution 206, the payment facilitator 208 can send a message to the customer's device 204, including instructions triggering the API therein to communicate with a back-end server 214 of the merchant that is connected to and that controls the rental object. The back-end server 214 then enables or unlocks the particular rental object being rented based on the rental information contained in the code, such as the type and/or duration of service. In the case of a laundry room, for example, the rental information may be for a specific washing machine X to be enabled for 30 minutes on a heavy-load mode.

As described, the payment facilitator 208 not only helps to process the payment request to ensure that the payment is correctly routed but can also provide a level of check. In some examples, the payment facilitator 208 may be configured to stop the back-end server 214 from enabling the rental object if the right amount is not provided during the push payment request. For example, if the available funds from the cardholder account associated with the customer are insufficient for the requested rental, a notification may be sent to the customer device 204.

A specific example is now described in connection with a rental locker; however, it would be appreciated that modifications and adaptations can be made to other rental objects.

In this example, a consumer may wish to rent a locker in a locker room containing multiple lockers, to store items. The lockers may be of different sizes, and the rental fee for a particular size may be at a fixed rate of, say $10 per locker of that size, regardless of the duration of storage. The consumer can choose the desired locker size at a centralized locker system which may be in the form of an interactive computer terminal, and is assigned an empty locker. A code, such as a barcode or QR code, is generated on the screen of the terminal. The consumer opens the mobile wallet app in his smart phone or tablet computer, and activates the P2M capability to scan the code. Once the code is acquired, a push payment request from the payment card stored in the mobile wallet is generated and the consumer can authenticate the payment. The code is also stored in the mobile wallet app. As described above, a card network or payment facilitator processes the payment requests and simultaneously opens the locker via the consumer's phone and the central terminal, for the consumer to store his items.

When the consumer returns to the locker room to retrieve the items from the rented locker, he can open the code stored in the mobile wallet app to be scanned by the interactive terminal. The system unlocks the relevant locker based on the code and informs the consumer of the locker number, e.g., via a display.

In the above example, the code is generated and managed by a centralized system, which can provide flexibility when there are changes and permutations. In other examples, the code may be affixed to a prominent position on the rental object, thereby removing the need to connect different rental objects to the centralized system and the associated expenses and technicalities.

As described, the method and systems of the example embodiments can benefit both the merchant and the consumer. For the merchant, the cost of deployment can be reduced compared to conventional systems because the merchant does not need to host or maintain an Internet payment gateway. Rather, the barcodes or QR codes can be generated and deployed in a cost-effective manner. For the consumer, the simple action of acquiring the code can trigger the push payment request and enable the rental object at the same time. This approach can also eliminate the step of transmitting the consumer's payment credentials, thereby potentially reducing fraud risks.

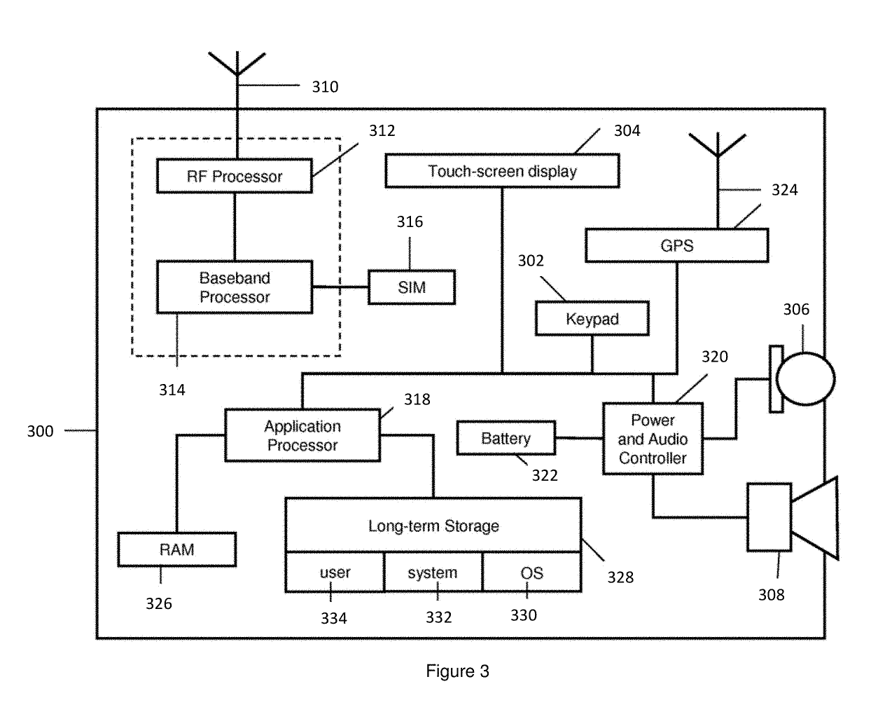

FIG. 3 shows a schematic of an exemplary wireless computing device 300 that may be utilized to implement the customer device (such as the customer device 204 in FIG. 2).

The wireless device 300 comprises a keypad 302, a touch-screen 304, a microphone 306, a speaker 308 and an antenna 310. The wireless device 300 is capable of being operated by a user to perform a variety of different functions, such as, for example, hosting a telephone call, sending an SMS message, browsing the Internet, sending an email and providing satellite navigation.

The wireless device 300 comprises hardware to perform communication functions (e.g., telephony, data communication), together with an application processor and corresponding support hardware to enable the wireless device 300 to have other functions, such as, messaging, Internet browsing, email functions and the like. The communication hardware is represented by a radio frequency (RF) processor 312 which provides an RF signal to the antenna 310 for the transmission of data signals, and the receipt therefrom. Additionally provided is a baseband processor 314, which provides signals to and receives signals from the RF processor 312. The baseband processor 314 also interacts with a subscriber identity module (SIM) 316, as is well known in the art. The communication subsystem enables the wireless device 300 to communicate via a number of different communication protocols including 3G, 4G, GSM, WiFi, Bluetooth™ and/or CDMA. The communication subsystem of the wireless device 300 is beyond the scope of the present disclosure.

The keypad 302 and the touch-screen 304 are controlled by an application processor 318. A power and audio controller 320 is provided to supply power from a battery 322 to the communication subsystem, the application processor 318, and the other hardware. The power and audio controller 320 also controls input from the microphone 306, and audio output via the speaker 308. Also provided is a global positioning system (GPS) antenna and associated receiver element 324 which is controlled by the application processor 318 and is capable of receiving a GPS signal for use with a satellite navigation functionality of the wireless device 300.

In order for the application processor 318 to operate, various different types of memory are provided. Firstly, the wireless device 300 includes Random Access Memory (RAM) 326 connected to the application processor 318 into which data and program code can be written and read from at will. Code placed anywhere in RAM 326 can be executed by the application processor 318 from the RAM 326. RAM 326 represents a volatile memory of the wireless device 300.

Secondly, the wireless device 300 is provided with a long-term storage 328 connected to the application processor 318. The long-term storage 328 comprises three partitions, an operating system (OS) partition 330, a system partition 332 and a user partition 334. The long-term storage 328 represents a non-volatile memory of the wireless device 300.

In the present example, the OS partition 330 contains the firmware of the wireless device 300 which includes an operating system. Other computer programs may also be stored on the long-term storage 328, such as application programs (also referred to as apps), and the like. In particular, application programs which are mandatory to the wireless device 300, such as, in the case of a smartphone, communications applications, and the like, are typically stored in the system partition 332. The application programs stored on the system partition 332 would typically be those which are bundled with the wireless device 300 by the device manufacturer when the wireless device 300 is first sold.

Application programs which are added to the wireless device 300 by the user would usually be stored in the user partition 334.

As stated, the representation of FIG. 3 is schematic. In practice, the various functional components illustrated may be substituted into one and the same component. For example, the long-term storage 328 may comprise NAND flash, NOR flash, a hard disk drive or a combination of these.

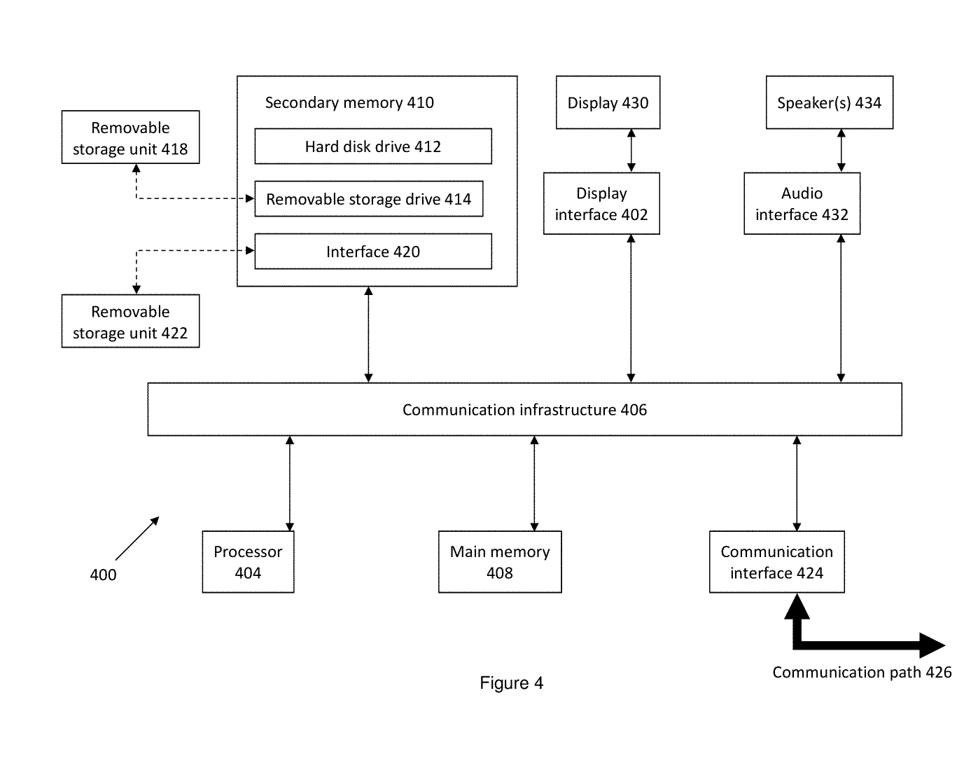

FIG. 4 depicts an exemplary computing device 400, hereinafter interchangeably referred to as a computer system 400, where one or more such computing devices 400 may be used for payment facilitator's system, the Originating Institution's system, the Receiving Institution's system or the merchant's back-end server 214 (FIG. 2). The following description of the computing device 400 is provided by way of example only and is not intended to be limiting.

As shown in FIG. 4, the example computing device 400 includes a processor 404 for executing software routines. Although a single processor is shown for the sake of clarity, the computing device 400 may also include a multi-processor system. The processor 404 is connected to a communication infrastructure 406 for communication with other components of the computing device 400. The communication infrastructure 406 may include, for example, a communications bus, cross-bar, or network.

The computing device 400 further includes a main memory 408, such as a random access memory (RAM), and a secondary memory 410. The secondary memory 410 may include, for example, a hard disk drive 412 and/or a removable storage drive 414, which may include a floppy disk drive, a magnetic tape drive, an optical disk drive, or the like. The removable storage drive 414 reads from and/or writes to a removable storage unit 418 in a well-known manner. The removable storage unit 418 may include a floppy disk, magnetic tape, optical disk, or the like, which is read by and written to by removable storage drive 414. As will be appreciated by persons skilled in the relevant art(s), the removable storage unit 418 includes a computer readable storage medium having stored therein computer executable program code instructions and/or data.

In an alternative implementation, the secondary memory 410 may additionally or alternatively include other similar means for allowing computer programs or other instructions to be loaded into the computing device 400. Such means can include, for example, a removable storage unit 422 and an interface 420. Examples of a removable storage unit 422 and interface 420 include a program cartridge and cartridge interface (such as that found in video game console devices), a removable memory chip (such as an EPROM or PROM) and associated socket, and other removable storage units 422 and interfaces 420 which allow software and data to be transferred from the removable storage unit 422 to the computer system 400.

The computing device 400 also includes at least one communication interface 424. The communication interface 424 allows software and data to be transferred between computing device 400 and external devices via a communication path 426. In various embodiments of the disclosure, the communication interface 424 permits data to be transferred between the computing device 400 and a data communication network, such as a public data or private data communication network. The communication interface 424 may be used to exchange data between different computing devices 400 which such computing devices 400 form part of an interconnected computer network. Examples of a communication interface 424 can include a modem, a network interface (such as an Ethernet card), a communication port, an antenna with associated circuitry, and the like. The communication interface 424 may be wired or may be wireless. Software and data transferred via the communication interface 424 are in the form of signals which can be electronic, electromagnetic, optical or other signals capable of being received by communication interface 424. These signals are provided to the communication interface via the communication path 426.

As shown in FIG. 4, the computing device 400 further includes a display interface 402 which performs operations for rendering images to an associated display 430 and an audio interface 432 for performing operations for playing audio content via associated speaker(s) 434.

As used herein, the term “computer program product” may refer, in part, to removable storage unit 418, removable storage unit 422, a hard disk installed in hard disk drive 412, or a carrier wave carrying software over communication path 426 (wireless link or cable) to communication interface 424. Computer readable storage media refers to any non-transitory tangible storage medium that provides recorded instructions and/or data to the computing device 400 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card, such as a PCMCIA card and the like, whether or not such devices are internal or external of the computing device 400. Examples of transitory or non-tangible computer readable transmission media that may also participate in the provision of software, application programs, instructions and/or data to the computing device 400 include radio or infra-red transmission channels as well as a network connection to another computer or networked device, and the Internet or Intranets including e-mail transmissions and information recorded on Websites, and the like.

The computer programs (also called computer program code) are stored in main memory 408 and/or secondary memory 410. Computer programs can also be received via the communication interface 424. Such computer programs, when executed, enable the computing device 400 to perform one or more features of embodiments discussed herein. In various embodiments, the computer programs, when executed, enable the processor 404 to perform features of the above-described embodiments. Accordingly, such computer programs represent controllers of the computer system 400.

Software may be stored in a computer program product and loaded into the computing device 400 using the removable storage drive 414, the hard disk drive 412, or the interface 420. Alternatively, the computer program product may be downloaded to the computer system 400 over the communications path 426. The software, when executed by the processor 404, causes the computing device 400 to perform functions of embodiments described herein.

It is to be understood that the embodiment of FIG. 4 is presented merely by way of example. Therefore, in some embodiments, one or more features of the computing device 400 may be omitted. Also, in some embodiments, one or more features of the computing device 400 may be combined together. Additionally, in some embodiments, one or more features of the computing device 400 may be split into one or more component parts.

It will be appreciated that the elements illustrated in FIG. 4 function to provide means for performing the various functions and operations of the servers as described in the above embodiments.

In an implementation, a server may be generally described as a physical device comprising at least one processor and at least one memory including computer program code. The at least one memory and the computer program code are configured to, with the at least one processor, cause the physical device to perform the requisite operations.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects to be illustrative and not restrictive.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112(f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for controlling access to a rental object, the system comprising:
a processor; and
a memory unit coupled to the processor;
wherein the rental object is connected to a network;
wherein the memory unit is configured to store data received from a customer device, the data comprising a code associated with the rental object and a payment request message responsive to the code; and
wherein the processor is configured to process the payment request message and simultaneously instruct a merchant device, via the network, to enable the rental object for use by the customer.

2. The system as claimed in claim 1, wherein the payment request message comprises a push payment request from a digital wallet in the customer device.

3. The system as claimed in claim 2, wherein the code comprises a merchant ID associated with the rental object, and wherein the processor is configured to process the payment request message based on the merchant ID.

4. The system as claimed in claim 1, wherein the code comprises rental information, and wherein the processor is configured to instruct the merchant device to enable the rental object for use by the customer based on the rental information.

5. The system as claimed in claim 1, wherein the code associated with the rental object comprises a barcode or a QR code.

6. The system as claimed in claim 1, wherein the code associated with the rental object comprises a static code.

7. The system as claimed in claim 1, wherein the code associated with the rental object comprises a dynamic code.

8. A method for controlling access to a rental object, the method comprising:
receiving, via a network, a payment request message from a customer device, the payment request message being generated in response to the customer device acquiring a code associated with the rental object; and
processing the payment request message while simultaneously instructing a merchant device, via the network, to enable the rental object for use by the customer.

9. The method as claimed in claim 8, wherein the payment request message comprises a push payment request from a digital wallet in the customer device.

10. The method as claimed in claim 9, wherein the code comprises a merchant ID associated with the rental object, and wherein processing the payment request message comprises crediting the payment based on the merchant ID.

11. The method as claimed in claim 8, wherein the code comprises rental information, and wherein the merchant device is instructed to enable the rental object for use by the customer based on the rental information.

12. The method as claimed in claim 8, wherein the code associated with the rental object comprises a barcode, and wherein acquiring the code comprises scanning the barcode by the customer device.

13. The method as claimed in claim 8, wherein the code associated with the rental object comprises a QR code, and wherein acquiring the code comprises scanning the QR code by the customer device.

14. The method as claimed in claim 8, wherein the code associated with the rental object comprises a static code.

15. The method as claimed in claim 8, wherein the code associated with the rental object comprises a dynamic code.

16. A non-transitory computer-readable storage media including executable instructions for controlling access to a rental object, which, when executed by at least one processor, cause the at least one processor to:
receive, via a network, a payment request message from a customer device, the payment request message being generated in response to the customer device acquiring a code associated with the rental object; and
process the payment request message while substantially simultaneously instructing a merchant device, via the network, to enable the rental object for use by the customer.
